(19) United States
(12) Patent Application Publication
(10) Pub. No.: US 2020/0032406 A1
(43) Pub. Date: Jan. 30, 2020

(54) Low Solubility Salts as an Additive in Gas Diffusion Electrodes for Increasing the CO2 Selectivity at High Current Densities

(71) Applicant: Siemens Aktiengesellschaft, München (DE)

(72) Inventors: Ralf Krause, Herzogenaurach (DE); Christian Reller, Minden (DE); Günter Schmid, Hemhofen (DE); Bernhard Schmid, Erlangen (DE)

(73) Assignee: Siemens Aktiengesellschaft, München (DE)

(21) Appl. No.: 16/491,889

(22) PCT Filed: Feb. 15, 2018
(86) PCT No.: PCT/EP2018/053756

§ 371 Date: Sep. 6, 2019

(30) Foreign Application Priority Data
Mar. 9, 2017 (DE) 10 2017 203 903.5

(51) Int. Cl. C25B 11/04; C25B 1/04

(52) U.S. Cl. CPC C25B 11/0431; C01B 32/50; C25B 11/0484; C25B 1/04

(57) ABSTRACT

Various embodiments include a gas diffusion electrode comprising: a) Ag, Au, Cu, and/or Pd; and b) a compound of (a) with a solubility in water at 25° C. and standard pressure of less than 0.1 mol/L. The compound is: M₁₋ₓX, M_{2-y}Y, M_{2-y}Y′_{w} or M_{3-z}Z. w≥2, 0≤x≤0.5, 0≤y≤1, and 0≤z≤1.5. X is: Cl, Br, Br₃, I, I₃, P₃, As₃, As₅, As₇, Sb₃, Sb₅, or Sb₇. Y and Y′ are: S, S, or Te. Z is: P, As, Sb, Bi, P₃, As₃, As₅, As₇, Sb₃, Sb₅, Sb₇, molybdates, tungstates, selenates, arsenates, vanadates, chromates, manganates, niobates of the metal M and thio and/or seleno derivatives of these, or compounds of the formula MₐX_{b}Y_{c}Z_{d} where a≥2, b≤4, c≤8, d≤4. b and c are not both 0.

### CROSS-REFERENCE TO RELATED APPLICATIONS

This application is a U.S. National Stage Application of International Application No. PCT/EP2018/053756 filed Feb. 15, 2018, which designates the United States of America, and claims priority to DE Application No. 10 2017 203 903.5 filed Mar. 9, 2017, the contents of which are hereby incorporated by reference in their entirety.

### TECHNICAL FIELD

The present disclosure relates to electrolysis. Various embodiments may include gas diffusion electrodes and/or processes for production thereof for use in the electrolysis of CO₂ and/or CO, corresponding electrolysis methods, and/or electrolysis cells comprising the gas diffusion electrode.

### BACKGROUND

The combustion of fossil fuels currently covers about 80% of global energy demand. These combustion processes emitted about 34 032.7 million metric tons of carbon dioxide (CO₂) globally into the atmosphere in 2011. This release is the simplest way of disposing of large volumes of CO₂ as well (brown coal power plants exceeding 50 000 t per day). Discussion about the adverse effects of the greenhouse gas CO₂ on the climate has led to consideration of reutilization of CO₂. In thermodynamic terms, CO₂ is at a very low level and can therefore be reduced again to usable products only with difficulty.

In nature, CO₂ is converted to carbohydrates by photosynthesis. This process, which is divided up into many component steps over time and spatially at the molecular level, is copiable on the industrial scale only with great difficulty. The more efficient route at present compared to pure photocatalysis is the electrochemical reduction of the CO₂. As opposed to light energy in photosynthesis, CO₂ is converted in this process with supply of pure electrical energy which is obtained from renewable energy sources such as wind or solar to a higher-energy product (such as CO, CH₄, C₂H₄, C₂H₅OH, etc.). The amount of energy required in this reduction corresponds ideally to the energy of combustion of the fuel and should come solely from renewable sources.

However, overproduction of renewable energies is not continuously available, but rather at present only in periods with intense insolation and strong wind. It is therefore viable to use CO₂ as a carbon source for the electrochemical production of higher-value products. By contrast with the hydrogen electrolyzers, the separation between products and reactants in the case of CO₂ electrolyzers is much more complex since both products and reactants are in gaseous form. Moreover, particularly in aqueous media, there is always a competing reaction between the formation of hydrogen and the intended CO₂ reduction products, preferably CO or ethylene, ethanol.

Silver-containing gas diffusion electrodes are used as what are called oxygen-depolarized cathodes in chloralkali electrolysis in order to suppress hydrogen formation by supply of gaseous oxygen at the cathode. This “integrated fuel cell” lowers the energy demand of chloralkali electrolysis by about 30%.

H₂O+O₂+2e⁻→2OH

This shows that such electrodes already have a relatively high overpotential for hydrogen formation (HER; hydrogen evolution reaction). Therefore, these electrodes can also be used as gas diffusion electrodes for the one-stage direct electrochemical reduction of CO₂ to CO in a wide variety of different cell concepts (e.g. CO₂ flowing past, CO₂ flowing by, PEM (polymer electrolyte membrane), half-PEM, with or without electrolyte gap concepts).

At current densities above 200-300 mA/cm², however, a significant HER is observed. In S. S. Neubauer, R. K. Krause, B. Schmid, D. M. Guldi, G. Schmid; Overpotentials and Faraday Efficiencies in CO₂ Electrocatalysis—the Impact of 1-Ethyl-3-Methylimidazolium Trifluoromethanesulfonate; Adv. Energy Mater. 2016, 1502231 and literature cited therein, ionic liquids are used to obtain a co-catalytic effect between silver electrode and ionic liquid that lowers the overpotential of the CO₂ reduction and increases that of the HER.

However, it has been found that the ionic liquids are unstable, especially at high current densities, and the cations thereof can be fully hydrolyzed (Sebastian S. Neubauer, Bernhard Schmid, Christian Reller, Dirk M. Guldi and Günter Schmid; Alkalinity Initiated Decomposition of Mediating Imidazolium Ions in High Current Density CO₂ Electrolysis; ChemElectroChem 2016, 3, 1-9).

It has been shown that silver electrodes anoxidized with oxygen plasma show significantly elevated selectivity of CO formation in the electrochemical CO₂ reduction. However, this effect is not stable over long periods since the silver oxide formed can be readily reduced back to silver during the electrolysis process. There is therefore a need for additions to gas diffusion electrodes, especially silver-containing gas diffusion electrodes, which, especially at high current densities, can increase the selectivity of the gas diffusion electrodes in CO₂ and/or CO electrolysis, for example of CO₂ relative to CO.

### SUMMARY

The teachings of the present disclosure include the use of sparingly soluble anions that are especially also additionally difficult to reduce to stabilize metal cations, for example Ag⁺ ions or Cu⁺ ions, in a gas diffusion electrode in such a way that reduction of the metal cations, for example of Ag⁺ or of Cu⁺, can be avoided during operation or reoxidation during the catalysis cycle is enabled again.

For example, some embodiments include a gas diffusion electrode comprising a) a metal M selected from Ag, Au, Cu, Pd and mixtures and/or alloys thereof, and b) a compound of the metal M, wherein the compound of the metal M has a solubility in water at 25° C. and standard pressure of less than 0.1 mol/L, wherein the compound of the metal M has a formula selected from M₁₋ₓX, M_{2-y}Y, M_{2-y}Y′_{w} and M_{3-z}Z, where 0≤x≤0.5; 0≤y≤1; 0≤z≤1.5; X is selected from Cl, Br, Br₃, I, I₃, P₃, As₃, As₅, As₇, Sb₃, Sb₅, Sb₇, and mixtures thereof; Y is selected from S, S, Te and mixtures thereof; Y′ is selected from S, Se, Te and mixtures thereof; w≥2; and Z is selected from P, As, Sb, Bi, P₃, As₃, As₅, As₇, Sb₃, Sb₅, Sb₇, and mixtures thereof; and/or is selected from molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M; and/or compounds of the formula MₐX_{b}Y_{c}Z_{d} where a≥2; 0≤b≤4; 0≤c≤8; 0≤d≤4; X is selected from Cl, Br, Br₃, I, I₃, P₃, As₃, As₅, As₇, Sb₃, Sb₅, Sb₇, and mixtures thereof; Y is selected from S, S, Te and mixtures thereof; and Z is selected from P, As, Sb, Bi, P₃, As₃, As₅, As₇, Sb₃, Sb₅, Sb₇, and mixtures thereof, where at least two of b and c are not simultaneously 0.

In some embodiments, the metal M in the compound of the metal M has a valency of 2 or less.

In some embodiments, the compound of the metal M has a redox potential relative to the standard hydrogen electrode at a pH of 7, a temperature of 25° C. and standard pressure that is below that of Ag₂O.

In some embodiments, there is a polymer binder. In some embodiments, the polymer binder has been modified with Ag⁺-binding groups.

As another example, some embodiments include a method of electrolysis of CO₂ and/or CO, wherein a gas diffusion electrode as described herein is used as cathode.

As another example, some embodiments include a process for producing a gas diffusion electrode, comprising a) a metal M selected from Ag, Au, Cu, Pd and mixtures and/or alloys thereof, and b) a compound of the metal M, wherein the compound of the metal M has a solubility in water at 25° C. and standard pressure of less than 0.1 mol/L, wherein a mixture comprising a powder of the metal M and a powder of the compound of the metal M is mixed and produced to give a gas diffusion electrode, or wherein a gas diffusion electrode comprising the metal M is electrochemically treated with a composition that leads to formation of a compound of the metal M that has a solubility in water at 25° C. and standard pressure of less than 0.1 mol/L, or wherein a gas diffusion electrode comprising the metal M is treated with a gaseous composition that leads to formation of a compound of the metal M that has a solubility in water at 25° C. and standard pressure of less than 0.1 mol/L, wherein the compound of the metal M has a formula selected from M₁₋ₓX, M_{2-y}Y, M_{2-y}Y′_{w} and M_{3-z}Z, where 0≤x≤0.5; 0≤y≤1; 0≤z≤1.5; X is selected from Cl, Br, Br₃, I, I₃, P₃, As₃, As₅, As₇, Sb₃, Sb₅, Sb₇, and mixtures thereof; Y is selected from S, S, Te and mixtures thereof; Y′ is selected from S, Se, Te and mixtures thereof; w≥2; and Z is selected from P, As, Sb, Bi, P₃, As₃, As₅, As₇, Sb₃, Sb₅, Sb₇, and mixtures thereof; and/or is selected from molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M; and/or compounds of the formula MₐX_{b}Y_{c}Z_{d} where a≥2; 0≤b≤4; 0≤c≤8; 0≤d≤4; X is selected from Cl, Br, Br₃, I, I₃, P₃, As₃, As₅, As₇, Sb₃, Sb₅, Sb₇, and mixtures thereof; Y is selected from S, S, Te and mixtures thereof; and Z is selected from P, As, Sb, Bi, P₃, As₃, As₅, As₇, Sb₃, Sb₅, Sb₇, and mixtures thereof, where at least two of b and c are not simultaneously 0.

In some embodiments, a mixture comprising the powder of the metal M and the powder of the compound of the metal M is mixed and produced to give a gas diffusion electrode, wherein the gas diffusion electrode is activated after the production.

In some embodiments, the activation is effected by treatment with a reducing agent in a solvent, e.g. at 20° C.-200° C., or wherein the activation is effected with a reducing gas or gas mixture.

In some embodiments, at least one binder, e.g. a polymer binder, is added to the gas diffusion electrode, or wherein at least one binder, e.g. a polymer binder, is mixed into the mixture comprising the powder of the metal M and the powder of the compound of the metal M, and this mixture is used to produce a gas diffusion electrode.

In some embodiments, the polymer binder has been modified with Ag⁺-binding groups.

As another example, some embodiments include an electrolysis cell comprising a gas diffusion electrode as described herein.

As another example, some embodiments include an electrolysis system comprising a gas diffusion electrode as described herein or an electrolysis cell as described herein.

### BRIEF DESCRIPTION OF THE DRAWINGS

The appended drawings are intended to illustrate embodiments of the teachings of the present disclosure and impart further understanding thereof. In connection with the description, they serve to elucidate concepts and principles of the disclosure, without thereby limiting its scope. Other embodiments and many of the advantages mentioned are apparent with regard to the drawings. The elements of the drawings are not necessarily shown true to scale with respect to one another. Elements, features and components that are the same, have the same function and the same effect are each given the same reference numerals in the figures of the drawings, unless stated otherwise.

FIG. 1 shows an illustrative diagram of a possible construction of an electrolysis cell in an example embodiment of the teachings of the present disclosure;

FIG. 2 shows a further illustrative diagram of a possible construction of an electrolysis cell in an example embodiment of the teachings of the present disclosure;

FIG. 3 shows a third illustrative diagram of a possible construction of an electrolysis cell in an example embodiment of the teachings of the present disclosure;

FIG. 4 shows a fourth illustrative diagram of a possible construction of an electrolysis cell in an example embodiment of the teachings of the present disclosure;

FIG. 5 shows one illustrative configuration of an electrolysis system for CO₂ reduction in an example embodiment of the teachings of the present disclosure;

FIG. 6 shows a further illustrative configuration of an electrolysis system for CO₂ reduction an example embodiment of the teachings of the present disclosure;

FIG. 7 shows a schematic diagram of an example embodiment of the teachings of the present disclosure comprising a gas diffusion electrode;

FIGS. 8 to 15 show Pourbaix diagrams calculated by way of example for various illustrative compounds of the metal M in which M is silver.

### DETAILED DESCRIPTION

Some embodiments of the teachings herein include a gas diffusion electrode comprising a metal M selected from Ag, Au, Cu, Pd and mixtures and/or alloys thereof, and a compound of the metal M, wherein the compound of the metal M has a solubility in water at 25° C. and standard pressure of less than 0.1 mol/L, wherein the compound of the metal M has a formula selected from M₁₋ₓX, M_{2-y}Y, M_{2-y}Y′_{w} and M_{3-z}Z, where 0≤x≤0.5; 0≤y≤1; 0≤z≤1.5; X is selected from Cl, Br, Br₃, I, I₃, P₃, As₃, As₅, As₇, Sb₃, Sb₅, Sb₇, and mixtures thereof; Y is selected from S, S, Te and mixtures thereof; Y′ is selected from S, Se, Te and mixtures thereof; w≥2; and Z is selected from P, As, Sb, Bi, P₃, As₃, As₅, As₇, Sb₃, Sb₅, Sb₇, and mixtures thereof; and/or is selected from molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M; and/or compounds of the formula MₐX_{b}Y_{c}Z_{d} where a≥2; 0≤b≤4; 0≤c≤8; 0≤d≤4; X is selected from Cl, Br, Br₃, I, I₃, P₃, As₃, As₅, As₇, Sb₃, Sb₅, Sb₇, and mixtures thereof; Y is selected from S, S, Te and mixtures thereof; and Z is selected from P, As, Sb, Bi, P₃, As₃, As₅, As₇, Sb₃, Sb₅, Sb₇, and mixtures thereof, where at least two of b and c are not simultaneously 0.

Some embodiments include a method of electrolysis of CO₂ and/or CO, wherein the gas diffusion electrode above is used as cathode. Some embodiments include a process for producing a gas diffusion electrode, comprising a metal M selected from Ag, Au, Cu, Pd and mixtures and/or alloys thereof, and a compound of the metal M, wherein the compound of the metal M has a solubility in water at 25° C. and standard pressure of less than 0.1 mol/L, wherein a mixture comprising a powder of the metal M and a powder of the compound of the metal M is mixed and produced to give a gas diffusion electrode, or wherein a gas diffusion electrode comprising the metal M is electrochemically treated with a composition that leads to formation of a compound of the metal M that has a solubility in water at 25° C. and standard pressure of less than 0.1 mol/L, or wherein a gas diffusion electrode comprising the metal M is treated with a gaseous composition that leads to formation of a compound of the metal M that has a solubility in water at 25° C. and standard pressure of less than 0.1 mol/L, wherein the compound of the metal M has a formula selected from M₁₋ₓX, M_{2-y}Y, M_{2-y}Y′_{w} and M_{3-z}Z, where 0≤x≤0.5; 0≤y≤1; 0≤z≤1.5; X is selected from Cl, Br, Br₃, I, I₃, P₃, As₃, As₅, As₇, Sb₃, Sb₅, Sb₇, and mixtures thereof; Y is selected from S, S, Te and mixtures thereof; Y′ is selected from S, Se, Te and mixtures thereof; w≥2; and Z is selected from P, As, Sb, Bi, P₃, As₃, As₅, As₇, Sb₃, Sb₅, Sb₇, and mixtures thereof; and/or is selected from molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M; and/or compounds of the formula MₐX_{b}Y_{c}Z_{d} where a≥2; 0≤b≤4; 0≤c≤8; 0≤d≤4; X is selected from Cl, Br, Br₃, I, I₃, P₃, As₃, As₅, As₇, Sb₃, Sb₅, Sb₇, and mixtures thereof; Y is selected from S, S, Te and mixtures thereof; and Z is selected from P, As, Sb, Bi, P₃, As₃, As₅, As₇, Sb₃, Sb₅, Sb₇, and mixtures thereof, where at least two of b and c are not simultaneously 0.

Some embodiments include an electrolysis cell comprising the gas diffusion electrode described herein. Further aspects of the present invention can be taken from the detailed description. Unless defined differently, technical and scientific expressions used herein have the same meaning as commonly understood by a person skilled in the art in the technical field of the invention.

“Hydrophobic” in the context of the present disclosure is understood to mean water-repellent-hydrophobic pores and/or channels are those that repel water. More particularly, hydrophobic properties are associated with substances or molecules having nonpolar groups. “Hydrophilic”, by contrast, is understood to mean the ability to interact with water and other polar substances.

In the disclosure, statements of amount are based on % by weight, unless stated otherwise or apparent from the context.

Standard pressure is 101 325 Pa=1.01325 bar.

The compound of the metal M that has a solubility in water at 25° C. and standard pressure of less than 0.1 mol/L is also referred to in the context of the description as compound of the metal M.

Some embodiments include a gas diffusion electrode comprising a metal M selected from Ag, Au, Cu, Pd and mixtures and/or alloys thereof, and a compound of the metal M, wherein the compound of the metal M has a solubility in water at 25° C. and standard pressure of less than 0.1 mol/L, of less than 0.05 mol/L, of less than 0.01 mol/L, less than 0.0001 mol/L, and/or of less than 1*10⁻¹⁰ mol/L, for example of less than 1*10⁻²⁰ mol/L. In some embodiments, the gas diffusion electrode may comprise more than one compound of the metal M that has a solubility in water at 25° C. and standard pressure of less than 0.1 mol/L, i.e., for example, 2 or more, for example 3, 4, 5, 6 or more, compounds of this kind. In particular embodiments, the gas diffusion electrode may consist of the metal M and the compound of the metal M that has a solubility in water at 25° C. and standard pressure of less than 0.1 mol/L.

The metal M serves both as catalyst and as electron conductor in the gas diffusion electrode. In some embodiments, the metal M is selected from Cu, Ag, Au, Pd and mixtures and/or alloys thereof. The metal M may be selected from Cu, Ag and mixtures and/or alloys thereof, e.g. Ag and/or alloys thereof.

The proportion of metal M in the gas diffusion electrode is not particularly restricted and may be between >0% and <100% by weight, based on the weight of the gas diffusion electrode, 10% by weight or more and 90% by weight or less, 20% by weight or more and 80% by weight or less, 30% by weight or more and 70% by weight or less.

The compound of the metal M is not particularly restricted in provided that it has a solubility in water at 25° C. and standard pressure of less than 0.1 mol/L, of less than 0.05 mol/L, of less than 0.01 mol/L, of less than 0.0001 mol/L, or of less than 1*10⁻¹⁰ mol/L, for example of less than 1*10⁻²⁰ mol/L. Such solubilities of compounds of the metal M can be found, for example, in product data sheets and/or determined in a simple manner by simple experiments, for example placing a fixed amount of the compound of the metal M in a particular volume of water, for example distilled, bidistilled, or triply distilled water, at 25° C. and standard pressure and measuring the concentration of ions released from the compound over time until attainment of a virtually constant value, and are consequently readily available to the person skilled in the art.

In some embodiments, the compound of the metal M additionally has a solubility in an aqueous solution of a salt comprising alkali metal and/or ammonium cations and/or derivatives of ammonium cations with any anions, for example halide anions, nitrate ions, carbonate ions, hydrogencarbonate ions, sulfate ions and/or hydrogensulfate ions with a concentration of anions and of cations of 1 mol/L or more a solubility at 25° C. and standard pressure of less than 0.1 mol/L, of less than 0.05 mol/L, of less than 0.01 mol/L, or of less than 0.0001 mol/L, of less than 1*10⁻¹⁰ mol/L, for example of less than 1*10⁻²⁰ mol/L. It is not ruled out here in the case of the compound of the metal M that the metal M is different in the compound of the metal M of the gas diffusion electrode, for example, Ag is provided as metal M and the compound of the metal M comprises Cu, Au, Pd, and mixtures and/or alloys thereof. In some embodiments, metal M of the compound of the metal M corresponds to the metal M of the gas diffusion electrode.

As is the case for the metal M, the proportion of compound of the metal M that has a solubility in water at 25° C. and standard pressure of less than 0.1 mol/L is not particularly restricted and may be between >0% and <100% by weight, based on the weight of the gas diffusion electrode, 10% by weight or more and 90% by weight or less, 20% by weight or more and 80% by weight or less, or 30% by weight or more and 70% by weight or less. In some embodiments, the proportion should be above the percolation threshold. In some embodiments, a mixture comprising metal M and the compound of the metal M is applied to a current distributor. In this case, the GDE may also comprise a number of layers.

In some embodiments, the compound of the metal M is a salt or an alloy, preferably a salt, i.e. in a formal sense has an ionic bond. In some embodiments, the compound of the metal M is inorganic. In some embodiments, the compound of the metal M is a semiconductor. In some embodiments, the metal M is thus present in the gas diffusion electrode both as elemental metal M and in cationic form—albeit bound within the compound of the metal M, e.g. as M+ and/or M²⁺ (especially Pd), or just M⁺.

In some embodiments, the metal M in the compound of the metal M has a valency of 2 or less, or of less than 2, for example 1. For instance, the metal M, if it is Ag, Au or Cu or a mixture or alloy thereof, has the valency of 1, whereas, if it is Pd, it has the valency of 2.

In some embodiments, the compound of the metal M has a formula selected from M₁₋ₓX, M_{2-y}Y, M_{2-y}Y′_{w} and M_{3-z}Z, where 0≤x≤0.5; 0≤y≤1; 0≤z≤1.5; 0≤x≤0.4; 0≤y≤0.8; 0≤z≤1.2; or 0≤x≤0.3; 0≤y≤0.6; 0≤z≤0.9; X is selected from Cl, Br, Br₃, I, I₃, P₃, As₃, As₅, As₇, Sb₃, Sb₅, Sb₇, and mixtures thereof, e.g. Cl, Br, Br₃, I, I₃, P₃, and mixtures thereof; Y is selected from S, S, Te and mixtures thereof; Y′ is selected from S, Se, Te and mixtures thereof, e.g. S, Se and mixtures thereof, e.g. S, Se; w≥2, preferably w≤10, e.g. w≤5; and Z is selected from P, As, Sb, Bi, P₃, As₃, As₅, As₇, Sb₃, Sb₅, Sb₇, and mixtures thereof, e.g. P, As, Sb, Bi, and mixtures thereof; and/or is selected from molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M; and/or compounds of the formula MₐX_{b}Y_{c}Z_{d} where a≥2, e.g. a≥3; 0≤b≤4, e.g. 0≤b≤3, e.g. 0≤b≤2, e.g. 0≤b≤1; 0≤c≤8, e.g. 0≤c≤6, e.g. 0≤c≤5, e.g. 0≤c≤4, e.g. 0≤c≤3, e.g. 0≤c≤2, e.g. 0≤c≤1; 0≤d≤4, e.g. 0≤d≤3, e.g. 0≤d≤2, e.g. 0≤d≤1; X is selected from Cl, Br, Br₃, I, I₃, P₃, As₃, As₅, As₇, Sb₃, Sb₅, Sb₇, and mixtures thereof, e.g. Cl, Br, Br₃, I, I₃, P₃, and mixtures thereof; Y is selected from S, S, Te and mixtures thereof; and Z is selected from P, As, Sb, Bi, P₃, As₃, As₅, As₇, Sb₃, Sb₅, Sb₇, and mixtures thereof, where at least two of b and c are not simultaneously 0. The compound of the metal M thus need not be stoichiometric here either and may also have mixed phases. Also included are ternary, quaternary etc. compounds, for example AgSbS₃, pyrargyrite, and Ag₃AsS₃, xanthoconite.

In some embodiments, the compound of the metal M is a compound of the formula Ia: M₁₋ₓX where 0≤x≤0.5; 0≤x≤0.4; or 0≤x≤0.3, and X is selected from Cl, Br, Br₃, I, I₃, P₃, As₃, As₅, As₇, Sb₃, Sb₅, Sb₇, and mixtures thereof, e.g. Cl, Br, Br₃, I, I₃, P₃, and mixtures thereof, for example including mixtures of Cl, Br, I, for example a compound of the formula I′a: Ag₁₋ₓX with X=F, Cl, Br, Br₃, I, I₃, P₃, As₃, As₅, As₇, Sb₃, Sb₅, Sb₇, or a mixture thereof, e.g. X=F, Cl, Br, Br₃, I, I₃, P₃, or a mixture thereof, e.g. a mixture of Cl, Br and/or I. Particularly some of the latter compounds of silver are photosensitive. For operation, however, this is usually immaterial since the electrodes in the electrolyzer are not exposed to daylight. Substoichiometric compounds with 0≤x≤0.5; 0≤x≤0.4; 0≤x≤0.3; e.g. 0≤x≤0.2; 0≤x≤0.1 are likewise suitable. In some embodiments, x=0. Examples of the compound Ia are, for example, AgCl, AgBr, AgI, AgP₃, CuCl, CuBr, CuI, AuCl, AuBr, AuI.

In some embodiments, the compound of the metal M is a chalcogen-based compound of the formula Ib: M_{2-y}Y, or I*: M_{2-y}Y′_{w}, where 0≤y≤1; 0≤y≤0.8; or0≤y≤0.6; Y is selected from S, S, Te and mixtures thereof; Y′ is selected from S, Se, Te and mixtures thereof, e.g. S, Se and mixtures thereof, e.g. S, Se; and w≥2, w≤10, e.g. w≤5, e.g. a compound of the formula I′b: Ag_{2y}Y or I*′b: Ag_{2y}Y′_{W} with Y=S, Se, Te or a mixture thereof; Y′=S, Se, Te or a mixture thereof, e.g. S, Se or a mixture thereof, e.g. S, Se; w≥2, or w≤10, e.g. w≤5. In some embodiments, the polymeric or oligomeric anions of sulfur or selenium Y′_{w}²⁻. Some of these compounds are semiconductive, such that the electrical coupling to the silver catalyst can be assured. Substoichiometric compounds with 0<y≤1; preferably 0<y≤0.8; further preferably 0<y≤0.6; e.g. 0<x≤0.4; 0<x≤0.2; 0<x≤0.1 are likewise suitable. In particular embodiments, y=0. Examples of the compound of the formula Ib are, for example, Ag₂S, Ag₂Se, Ag₂Te, Cu₂S, Cu₂Se, Cu₂Te, Au₂S, and examples of the compound of the formula I′b are, for example, Ag₂(S₂), Ag₂(Se₂), Cu₂(S₂), Cu₂(Se₂), etc.

In some embodiments, the compound of the metal M is a compound of the formula Ic: M_{3-z}Z where 0≤z≤1.5; 0≤z≤1.2; or 0≤z≤0.9; and Z is selected from P, As, Sb, Bi, P₃, As₃, As₅, As₇, Sb₃, Sb₅, Sb₇, and mixtures thereof, e.g. a compound of the formula I′c: Ag_{3z}Z with Z=P, As, Sb, Bi, P₃, As₃, As₅, As₇, Sb₃, Sb₅, Sb₇, or a mixture thereof. Some of these compounds are semiconductive or metallically conductive, such that the electrical coupling to the silver catalyst can be assured. Substoichiometric compounds with 0<z≤1.5; 0<z≤1.2; or 0<z≤0.9; e.g. 0<x≤0.6; 0<x≤0.4; 0<x≤0.2; 0<x≤0.1 are likewise suitable. In some embodiments, z=0. Examples of the compound of the formula Ic are, for example, Ag₃P, Ag₃As, Ag₃Sb, Ag₃Bi, Cu₃P, Cu₃As, Cu₃Sb, Cu₃Bi.

In some embodiments, compounds of the metal M with heavy anions such as molybdate, tungstate, arsenate, selenate, vanadate, chromate, manganate in various oxidation states are used, niobate or thio and/or seleno derivatives thereof. These anions may also be in polymeric form in the form of polyoxometalates. These are then used primarily in the form of their silver salts. Likewise encompassed are mineral compounds of the metal M, for example of the formula MₐX_{b}Y_{c}Z_{d} where a≥2, e.g. a≥3; 0≤b≤4, e.g. 0≤b 3, e.g. 0≤b≤2, e.g. 0≤b≤1; 0≤c≤8, e.g. 0≤c≤6, e.g. 0≤c≤5, e.g. 0≤c≤4, e.g. 0≤c≤3, e.g. 0≤c≤2, e.g. 0≤c≤1; 0≤d≤4, e.g. 0≤d≤3, e.g. 0≤d≤2, e.g. 0 d≤1; X is selected from Cl, Br, Br₃, I, I₃, P₃, As₃, As₅, As₇, Sb₃, Sb₅, Sb₇, and mixtures thereof, e.g. Cl, Br, Br₃, I, I₃, P₃, and mixtures thereof; Y is selected from S, S, Te and mixtures thereof; and Z is selected from P, As, Sb, Bi, P₃, As₃, As₅, As₇, Sb₃, Sb₅, Sb₇, and mixtures thereof, e.g. P, As, Sb, Bi, and mixtures thereof, where at least two of b and c are not simultaneously 0, e.g. AgSbS₃, pyrargyrite, and Ag₃AsS₃, xanthoconite.

The compounds of the metal M that are mentioned in the context of the disclosure may occur in different polymorphs that may differ in terms of their crystal structure. As well as the compounds described, for example, also known are the following ternary compounds: AgSbS₃, pyrargyrite, Ag₃AsS₃, xanthoconite, which may be used in gas diffusion electrodes.

In some embodiments, the compound of the metal M has a redox potential relative to the standard hydrogen electrode at a pH of 7, a temperature of 25° C. and standard pressure which is below that of Ag₂O.

In some embodiments, the compound of the metal M has a standard potential ε₀ which, in a Pourbaix diagram, at least at a pH of about 7, preferably from about 6 to about 8, more preferably from about 5 to about 9, even more preferably from about 4 to about 9.5, for example from about 3 to about 10 or from about 2, 1, 0 or less than about 11, 12, 13, 14 or more, is below that of AgO₂, preferably below that of Ag₂O. The standard potential ε₀ can be ascertained, for example, with the aid of the Nernst equation.

Pourbaix diagrams show the thermodynamic stability of individual phases in an aqueous system with respect to the electrode potential. For an electrocatalyst, the phase existence region should be close to the working potential. Especially by means of nanostructured catalysts, it is possible to achieve thermodynamically unstable states of the solid species that enable reformation of the oxidized species that does not exist under equilibrium conditions.

For example, the Pourbaix diagram for the silver-water system has a very narrow existence region for Ag⁺ and Ag₂O at the thermodynamic equilibrium. In the case of negative potentials <−1 V, existence is therefore somewhat questionable and is more likely to be conceivable far from the thermodynamic equilibrium. On the other hand, for example, Pourbaix diagrams for the AgCl and AgBr systems have much broader existence regions. The strongly complexing effect of halides and the formation of sparingly soluble compounds, such as AgCl and AgBr, promotes existence at more negative potentials. As soon as oxidation takes place, complexation can proceed.

As a further example, the Pourbaix diagram of the Ag—S system shows a relatively broad existence region for sparingly soluble silver sulfide (Ag₂S). The phase is stable under equilibrium conditions at negative electrode potential down to −0.8 V vs. Ag/AgCl. Under real electrolysis conditions of, for example, −1.5 to −1.6 V vs. Ag/AgCl, existence is thus probable. Similarly, the Ag—Se system has a very broad existence region for the Ag₂Se phase, which is stable under equilibrium conditions down to a potential of −1.0 V vs. Ag/AgCl. Ag₂Se is sparingly soluble and is a semiconductor, which means that the material is suitable for production of electrodes. It can be synthesized, for example, from silver and selenium at 400° C. Here too, existence under real electrolysis conditions, for example as specified above, is probable. As a further example, the Ag—Te system has the phases Ag₂Te, Ag_{1.64}Te, which are stable down to a potential of −1.3 V vs. Ag/AgCl. Ag₂Te can be obtained from silver and tellurium at 470° C. and likewise has semiconductive properties.

In yet a further example, the Pourbaix diagram for the Ag₃Sb system (dyscrasite) shows a very broad existence region for the Ag₃Sb phase, which exists down to a potential of −2 V versus Ag/AgCl over a pH range of 0-14. The Ag—P system additionally has a narrow phase existence region for AgP₃, silver triphosphide, in the acidic medium down to −1.3 V vs. Ag/AgCl.

In some embodiments, the competing hydrogen formation can be suppressed by mixing metal in positive oxidation states, e.g. M⁺, e.g. Ag⁺, into the gas diffusion electrode. However, it has been found that metal oxides, for example, such as silver oxide, can be reduced to silver under operating conditions. This basically corresponds to the standard procedure of the activation of a gas diffusion electrode. In order to avoid this reduction, the corresponding compound of the metal M, e.g. silver halides, chalcogenides and/or pnictides, is then mixed into the metal, for example the silver component of the electrode. As set out above, complex anions that are difficult to reduce are also possible.

In some embodiments, the electrode is a gas diffusion electrode. The gas diffusion electrode here is not particularly restricted with regard to its configuration, provided that, as usual in the case of gas diffusion electrodes, three states of matter—solid, liquid and gaseous—can be in contact with one another and the solid matter of the electrode has at least one electron-conducting catalyst capable of catalyzing an electrochemical reaction between the liquid phase and the gaseous phase.

In some embodiments, there are hydrophobic channels and/or pores or regions and possibly hydrophilic channels and/or pores or regions on the electrolyte side in the gas diffusion electrode (GDE), where catalyst sites may be present in the hydrophilic regions. On a gas side of the gas diffusion electrode, this may comprise hydrophobic channels and/or pores. In this respect, the gas diffusion electrode may comprise at least two sides, one with hydrophilic and optionally hydrophobic regions and one with hydrophobic regions.

Particularly active catalyst sites in a GDE lie in the liquid/solid/gaseous three-phase region. An ideal GDE thus has maximum penetration of the bulk material with hydrophilic and hydrophobic channels and/or pores in order to obtain a maximum number of three-phase regions for active catalyst sites.

As well as the metal M and the solid electrolyte, the electrode may also comprise further constituents, for example a substrate to which the solid electrolyte and the metal M may be applied, and/or at least one binding agent/binder. The substrate here is not particularly restricted and may comprise, for example, a metal such as silver, platinum, nickel, lead, titanium, nickel, iron, manganese, copper or chromium or alloys thereof, such as stainless steels, and/or at least one nonmetal such as carbon, Si, boron nitride (BN), boron-doped diamond, etc., and/or at least one conductive oxide such as indium tin oxide (ITO), aluminum zinc oxide (AZO) or fluorinated tin oxide (FTO)—for example for production of photoelectrodes, and/or at least one polymer based on polyacetylene, polyethoxythiophene, polyaniline or polypyrrole, as, for example, in polymer-based electrodes. In particular embodiments, however, the substrate may be formed essentially by the metal M, optionally with at least one binding agent and if appropriate with the compound of the metal M that has a solubility in water at 25° C. and standard pressure of less than 0.1 mol/L.

The binding agent or binder for the gas diffusion electrode, if present, is not particularly restricted and includes, for example, a hydrophilic and/or hydrophobic polymer, for example a hydrophobic polymer, especially PTFE (polytetrafluoro-ethylene). This can achieve a suitable adjustment of the hydrophobic pores or channels. More particularly, the gas diffusion electrode can be produced using PTFE particles having a particle diameter between 5 and 95 μm, or between 8 and 70 μm. Suitable PTFE powders include, for example, Dyneon® TF 9205 or Dyneon TF 1750. Suitable binder particles, for example PTFE particles, may, for example, be approximately spherical, for example spherical, and may be produced, for example, by emulsion polymerization. In some embodiments, the binder particles are free of surface-active substances. The particle size can be determined here, for example, according to ISO 13321 or D4894-98a and may correspond, for example, to the manufacturer data (e.g. TF 9205: average particle size 8 μm to ISO 13321; TF 1750: average particle size 25 μm to ASTM D4894-98a). A binding agent may be present, for example, in a proportion of 0.01% to 30% by weight, preferably 0.1% to 10% by weight, based on the gas diffusion electrode.

In some embodiments, the gas diffusion electrode comprises at least one polymer binder as binder. In some embodiments, the polymer binder has been modified with metal cation-binding (e.g. M⁺- and/or M²⁺-binding) groups, e.g. Ag⁺-binding groups. One example of a polymer binder having Ag⁺-binding groups is, for example, a polyacrylate, the cations of which may consist entirely or partly of Ag⁺.

Similarly, it is also possible to add a polymer binder to the GDE that has been modified with metal cation-binding (e.g. M⁺- and/or M²⁺-binding) groups, e.g. Ag⁺-binding groups, for example R—S⁻, R—COO⁻, R—NR′R″, where R may be an organic radical and R′ and R″ may, for example, be H or organic radicals, for example R represents a radical of the polymer and R′, R″ may comprise, for example, 1 to 20 carbon atoms and/or be H, and, for example, is in cationic form, for example the Ag⁺ form.

In some embodiments, the electrode, especially as gas diffusion electrode, comprises or consists of metal M, the compound of the metal M and the binder.

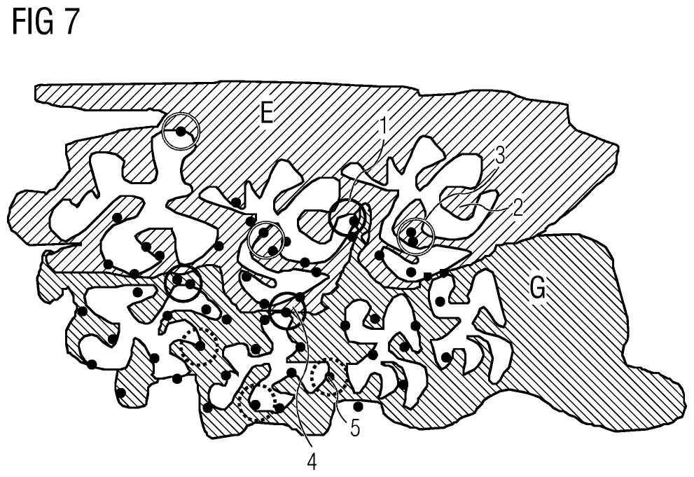

FIG. 7 illustrates the relationships between hydrophilic and hydrophobic regions in an illustrative GDE having two layers that can achieve a good liquid/solid/gaseous three-phase relationship. In this case, for example, there are hydrophobic channels or regions 1 and hydrophilic channels or regions 2 on the electrolyte side E in the electrode, where catalyst sites 3 of low activity may be present in the hydrophilic regions 2 and can be provided by the compound of the metal M. In addition, there are inactive catalyst sites 5 on the side of the gas G.

Particularly active catalyst sites 4 are in the liquid/solid/gaseous three-phase region. An ideal GDE can thus have maximum penetration of the bulk material with hydrophilic and hydrophobic channels in order to obtain a maximum number of three-phase regions for active catalyst sites.

In some embodiments, there is a gas diffusion electrode having just one layer, provided that the gas diffusion electrode comprises the metal M and the compound of the metal M. In such a single-layer embodiment, it is then possible for the hydrophilic and hydrophobic regions, for example pores and/or channels, also to be present in the one layer, such that predominantly hydrophilic and predominantly hydrophobic regions can be established in the layer. The elucidation of the catalyst sites here is then analogous to the two-layer construction described by way of example.

In some embodiments, there is a method of electrolysis of CO₂ and/or CO, wherein the gas diffusion electrode of the invention is used as cathode. The method of electrolysis of CO₂ and/or CO is not particularly restricted beyond that, especially with regard to the second half-cell of the electrolysis, the supply of reactants, the supply and removal of electrolyte, the removal of products, the construction of the electrolysis cell or an electrolysis system, etc.

In some embodiments, there is a process for producing a gas diffusion electrode, comprising a metal M selected from Ag, Au, Cu, Pd and mixtures and/or alloys thereof, and a compound of the metal M, wherein the compound of the metal M has a solubility in water at 25° C. and standard pressure of less than 0.1 mol/L, of less than 0.05 mol/L, of less than 0.01 mol/L, or of less than 0.0001 mol/L, of less than 1*10⁻¹⁰ mol/L, for example of less than 1*10⁻²⁰ mol/L, wherein a mixture comprising a powder of the metal M and a powder of the compound of the metal M is mixed and produced to give a gas diffusion electrode, or wherein a gas diffusion electrode comprising the metal M is electrochemically treated with a composition that leads to formation of a compound of the metal M that has a solubility in water at 25° C. and standard pressure of less than 0.1 mol/L, preferably of less than 0.05 mol/L, more preferably of less than 0.01 mol/L, even more preferably of less than 0.0001 mol/L, especially preferably of less than 1*10⁻¹⁰ mol/L, for example of less than 1*10⁻²⁰ mol/L, or wherein a gas diffusion electrode comprising the metal M is treated with a gaseous composition that leads to formation of a compound of the metal M that has a solubility in water at 25° C. and standard pressure of less than 0.1 mol/L, of less than 0.05 mol/L, of less than 0.01 mol/L, of less than 0.0001 mol/L, or of less than 1*10⁻¹⁰ mol/L, for example of less than 1*10⁻²⁰ mol/L.

By this production process, it is especially possible to produce the gas diffusion electrode, such that the corresponding features of the gas diffusion electrode can also find use in this production process. More particularly, it is also possible to suitably adjust the proportions by weight of the constituents in the production in accordance with the proportions by weight of the gas diffusion electrode.

In some embodiments, at least one binder, e.g. a polymer binder, is added to the gas diffusion electrode, or at least one binder, e.g. a polymer binder, is mixed into the mixture comprising the powder of the metal M and the powder of the compound of the metal M, and this mixture is used to produce a gas diffusion electrode. In some embodiments, the polymer binder has been modified with metal cation-binding (e.g. M⁺- and/or M²⁺-binding) groups, e.g. Ag⁺-binding groups. The production of the gas diffusion electrode is not particularly restricted and can be effected by rolling for example, as specified in DE 10 2015 215309.6 for example.

For example, Ag-based catalyst powders, prior to pressing of the gas diffusion electrode, can be supplemented by Ag⁺ admixtures, for example the above-specified compounds such as Ag₂S, where the amount of the admixture may be between >0-<100% by weight. Subsequently, the catalyst mixture can be used to produce gas diffusion electrodes, optionally with the corresponding admixtures, for example binders, by means of rolling technology.

In some embodiments, a mixture comprising the powder of the metal M and the powder of the compound of the metal M and optionally at least one binder are mixed and produced to give a gas diffusion electrode, wherein the gas diffusion electrode is activated after the production. Especially when the electrode is nonconductive as a result of high proportions of admixtures, it can be activated by means of wet- or dry-chemical methods prior to use thereof.

In some embodiments, the activation is effected by treatment with a reducing agent in a solvent, e.g. at 20° C.-200° C., or the activation is effected with a reducing gas or gas mixture. By wet-chemical means, for example in organic solvents or water, the reducing agent can be sucked or forced through the GDE until the desired degree of reduction is achieved. Examples of useful reducing agents include hydrazine or hydrides such as lithium aluminum hydride, sodium borohydride, but also organic substances such as formaldehyde, sugars, ascorbic acid, alcohols, polyols, polyvinyl alcohol. Preferred temperatures here are in the range between 20 and 300° C., preferably between 25 and 250° C., for example between 30 and 200° C.

Dry activation can be effected, for example, with hydrogen or forming gas of different composition, for example within the temperature range of 30-350° C., preferably 50-250° C., according to the binder or binder polymer.

In the production, it is also possible to treat a gas diffusion electrode comprising the metal M electrochemically with a composition that leads to formation of a compound of the metal M that has a solubility in water at 25° C. and standard pressure of less than 0.1 mol/L, or it is possible to treat a gas diffusion electrode comprising the metal M with a gaseous composition that leads to formation of a compound of the metal M that has a solubility in water at 25° C. and standard pressure of less than 0.1 mol/L.

For example, it is possible to aftertreat commercial gas diffusion electrodes made of silver by different methods. For example, it is possible to achieve halide functionalization by connecting the electrode as anode in a halide solution (e.g. 0.01-3 mol), for example for 0.1-10 min. The halogen formed is then oxidized by silver to the corresponding halide. In addition, for example, chalcogenide functionalization can be effected by direct reaction of the electrode from the gas phase, for example in sulfur or selenium vapor at temperatures of 100-200° C. at a pressure of 10⁻³-10⁻⁴ mbar. Similarly, for example, sulfur functionalization can be effected with reagents such as benzyl trisulfide. The processes here are not particularly restricted.

In some embodiments, there is an electrolysis cell comprising the gas diffusion electrode, for example as cathode. The further constituents of the electrolysis cell, for instance the anode, optionally a membrane, feed(s) and drain(s), the voltage source, etc., and further optional devices such as cooling or heating units are not particularly restricted in accordance with the invention, nor are anolytes and/or catholyte that are used in such an electrolysis cell, where the electrolysis cell, in particular embodiments, is used on the cathode side for reduction of carbon dioxide and/or CO. In some embodiments, the configuration of the anode space and of the cathode space is likewise not particularly restricted.

Examples of configurations for an illustrative construction of a typical electrolysis cell and of possible anode and cathode spaces are shown in FIGS. 1 to 4.

An electrochemical reduction of, for example, CO₂ and/or CO takes place in an electrolysis cell that typically consists of an anode and a cathode space. FIGS. 1 to 4 below show examples of a possible cell arrangement. For each of these cell arrangements it is possible to use a gas diffusion electrode, for example as cathode.

By way of example, the cathode space II in FIG. 1 is configured such that a catholyte is supplied from the bottom, and it leaves the cathode space II at the top. Alternatively, the catholyte can also be supplied from the top, as, for example, in the case of falling-film electrodes. CO₂ and/or CO, for example, can be supplied via the gas diffusion electrode K. At the anode A, which is electrically connected to the cathode K by means of a power source for provision of the voltage for the electrolysis, the oxidation of a substance which is supplied from the bottom, for example with an anolyte, takes place in the anode space I, and the anolyte then leaves the anode space together with the product of the oxidation.

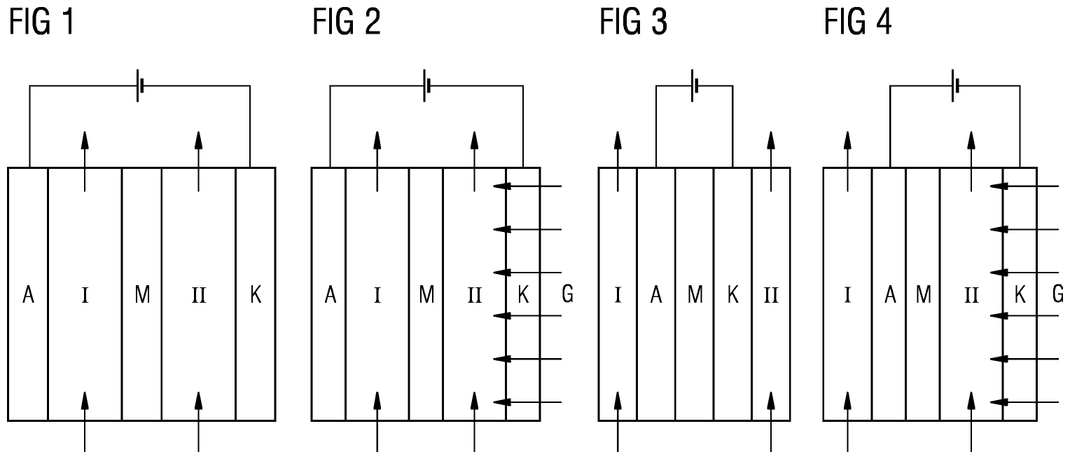

This 2-chamber construction differs from the 3-chamber construction in FIG. 2 in that a reaction gas, for example carbon dioxide or CO, can be conveyed into the cathode space II for reduction through a porous gas diffusion electrode as cathode. Although they are not shown, embodiments with a porous anode are also conceivable. Both in FIG. 1 and in FIG. 2, the spaces I and II are separated by a membrane M. By contrast, in the PEM (proton or ion exchange membrane) construction of FIG. 3, a porous cathode K and a porous anode A directly adjoin the membrane M, which separates the anode space I from the cathode space II. The construction in FIG. 4 corresponds to a mixed form of the construction from FIG. 2 and the construction from FIG. 3, with provision on the catholyte side of a construction with a gas diffusion electrode, as shown in FIG. 2, whereas a construction as in FIG. 3 is provided on the anolyte side. Of course, mixed forms or other configurations of the electrode spaces shown by way of example are also conceivable.

Also conceivable are embodiments without a membrane. In some embodiments, the cathode-side electrolyte and the anode-side electrolyte may thus be identical, and the electrolysis cell/electrolysis unit need not have a membrane. However, it is not ruled out that the electrolysis cell, in such embodiments, has one or more membranes, for example 2, 3, 4, 5, 6 or more membranes, which may be the same or different, but this is associated with additional complexity with regard to the membrane and also the voltage applied. Catholyte and anolyte may optionally also be mixed again outside the electrolysis cell.

FIGS. 1 to 4 are schematic diagrams. The electrolysis cells from FIGS. 1 to 4 may also be combined to form mixed variants. For example, the anode space may be executed as a PEM half-cell, as in FIG. 3, while the cathode space consists of a half-cell containing a certain electrolyte volume between membrane and electrode, as shown in FIG. 1. In some embodiments, the distance between electrode and membrane is very small or 0 when the membrane is in porous form and includes a feed for the electrolyte. The membrane may also be in multilayer form, such that separate feeds of anolyte and catholyte are enabled. Separation effects in the case of aqueous electrolytes can be achieved, for example, by virtue of the hydrophobicity of interlayers and/or a corresponding adjustment of the prevailing capillary forces. Conductivity can nevertheless be assured when conductive groups are integrated into such separation layers. The membrane may be an ion-conductive membrane or a separator that brings about merely a mechanical separation and is permeable to cations and anions.

In some embodiments, there is a gas diffusion electrode that enables construction of a three-phase electrode. For example, a gas can be supplied to the electrically active front side of the electrode from the back, in order to implement the electrochemical reaction there. In particular embodiments, the flow may also merely pass by the gas diffusion electrode, meaning that a gas such as CO₂ and/or CO is guided past the reverse side of the gas diffusion electrode in relation to the electrolyte, in which case the gas can penetrate through the pores of the gas diffusion electrode and the product can be removed at the back. It has been found that, even though a gas such as CO₂ does not “bubble” through the electrolyte, similarly high Faraday efficiencies (FE) of products are nevertheless found. For example, the gas flow in the case of flow-by is also reversed relative to the flow of the electrolyte in order that any liquid forced through can be transported away. In this case too, a gap between the gas diffusion electrode and the membrane is advantageous as electrolyte reservoir.

The supply of a gas can additionally also be accomplished in another way for the gas diffusion electrode shown in FIG. 3, for example in the case of supply of CO₂. By virtue of the gas, e.g. CO₂, being guided through the electrode in a controlled manner, it is again possible to rapidly discharge the reduction products.

In some embodiments, the electrolysis cell has a membrane that separates the cathode space and the anode space of the electrolysis cell in order to prevent mixing of the electrolytes. The membrane is not particularly restricted here, provided that it separates the cathode space and the anode space. More particularly, it essentially prevents passage of the gases formed at the cathode and/or anode to the anode space or cathode space. In some embodiments, the membrane is an ion exchange membrane, for example a polymer-based ion exchange membrane. In some embodiments, the ion exchange membrane is a sulfonated tetrafluoroethylene polymer such as Nafion®, for example Nafion® 115. As well as polymer membranes, it is also possible to use ceramic membranes, for example those mentioned in EP 1685892 A1 and/or zirconia-laden polymers, e.g. polysulfones.

Similarly, the material of the anode is not particularly restricted and depends primarily on the desired reaction. Illustrative anode materials include platinum or platinum alloys, palladium or palladium alloys and glassy carbon. Further anode materials are also conductive oxides such as doped or undoped TiO₂, indium tin oxide (ITO), fluorine-doped tin oxide (FTO), aluminum-doped zinc oxide (AZO), iridium oxide, etc. These catalytically active compounds may optionally also merely be applied to the surface using thin-film technology, for example on a titanium and/or carbon carrier.

Likewise disclosed is an electrolysis system comprising an electrode or an electrolysis cell as described herein. An abstract diagram of an apparatus of a general electrolysis system is shown in FIG. 5. FIG. 5 shows, by way of example, an electrolysis in which carbon dioxide is reduced on the cathode side and water is oxidized on the anode A side, although other reactions also proceed, for example on the anode side. On the anode side, in further examples, it would be possible for a reaction of chloride to give chlorine, bromide to give bromine, sulfate to give peroxodisulfate (with or without evolution of gas), etc. to take place. Examples of suitable anodes A are platinum or iridium oxide on a titanium carrier, and an example of a cathode K is an electrode as described herein. The two electrode spaces of the electrolysis cell are separated by a membrane M, for example of Nafion®. The incorporation of the cell into a system with anolyte circuit 10 and catholyte circuit 20 is shown in schematic form in FIG. 5.

On the anode side, in this illustrative embodiment, water with electrolyte additions is fed into an electrolyte reservoir vessel 12 via an inlet 11. However, it is not impossible that water is supplied additionally or instead of the inlet 11 at another point in the anolyte circuit 10, since, according to FIG. 5, the electrolyte reservoir vessel 12 is also used for gas separation. The water is pumped out of the electrolyte reservoir vessel 12 by means of the pump 13 into the anode space, where it is oxidized. The product is then pumped back into the electrolyte reservoir vessel 12, where it can be led off into the product gas vessel 14. The product gas can be removed from the product gas vessel 14 via a product gas outlet 15. It is of course also possible for the product gas to be separated off elsewhere, for example in the anode space as well. The result is thus an anolyte circuit 10 since the electrolyte is circulated on the anode side.

On the cathode side, in the catholyte circuit 20, carbon dioxide is introduced via a CO₂ inlet 22 into an electrolyte reservoir vessel 21, where it is physically dissolved for example. By means of a pump 23, this solution is brought into the cathode space, where the carbon dioxide is reduced at the cathode K. An optional further pump 24 then pumps the solution obtained at the cathode K further to a vessel for gas separation 25, where a product gas can be led off into a product gas vessel 26. The product gas can be removed from the product gas vessel 26 via a product gas outlet 27. The electrolyte is in turn pumped out of the vessel for gas separation back to the electrolyte reservoir vessel 21, where carbon dioxide can be added again. Here too, merely an illustrative arrangement of a catholyte circuit 20 is specified, and the individual apparatus components of the catholyte circuit 20 may also be arranged differently, for example in that the gas separation is effected at an early stage in the cathode space. In some embodiments, the gas separation and gas saturation are effected separately, meaning that the electrolyte is saturated with CO₂ in one of the vessels and then is pumped through the cathode space as a solution without gas bubbles. The gas that leaves the cathode space may then, in particular embodiments, consist to a predominant degree of product gas since CO₂ itself remains dissolved since it has been consumed, and hence the concentration in the electrolyte is somewhat lower.

The electrolysis is effected in FIG. 5 by addition of current via a current source (not shown). In order to be able to control the flow of the water and of the CO₂ dissolved in the electrolyte, valves 30 may optionally be introduced in the anolyte circuit 10 and catholyte circuit 20. The valves 30 are shown in the figure upstream of the inlet into the electrolysis cell, but may also be provided, for example, downstream of the outlet from the electrolysis cell and/or elsewhere in the anolyte circuit or catholyte circuit. It is also possible, for example, for a valve 30 to be upstream of the inlet into the electrolysis cell in the anolyte circuit, while the valve in the catholyte circuit is beyond the electrolysis cell, or vice versa.

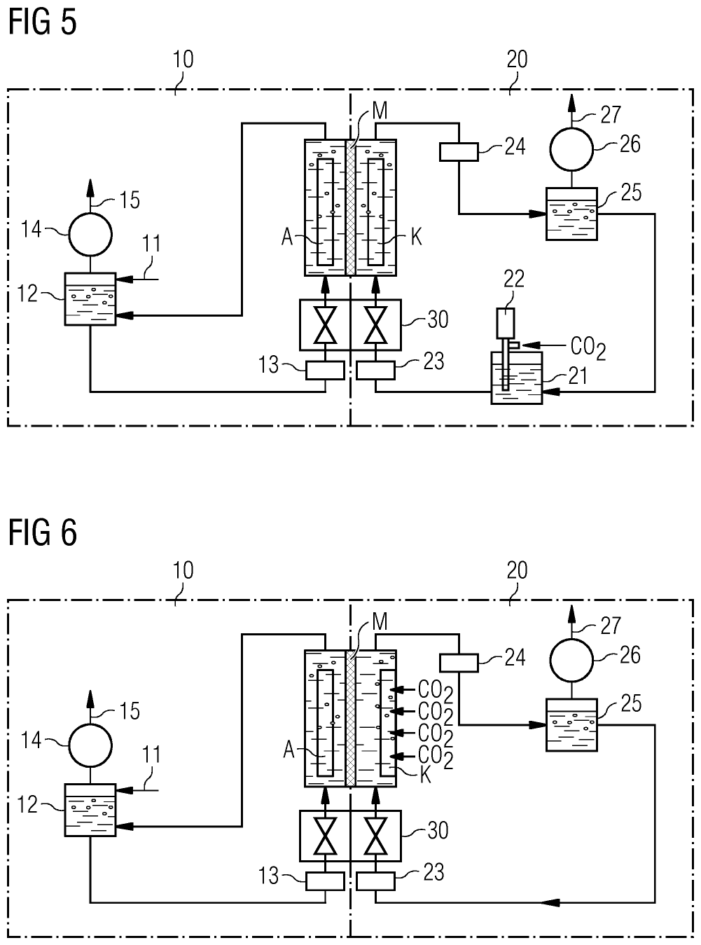

An abstract diagram of an illustrative apparatus of an electrolysis system is shown in FIG. 6. The apparatus in FIG. 6 corresponds here to that of FIG. 5, with introduction of the addition of carbon dioxide into an electrolyte reservoir vessel 21 not via a CO₂ inlet 22, but directly via the cathode which is configured here as a gas diffusion electrode. In this case, the CO₂ can be supplied, for example, by flow-by or flow-through of a porous cathode.

The composition of a liquid or solution, for example an electrolyte solution, which is supplied to the electrolysis unit is not particularly restricted here, and may include all possible liquids or solvents, for example water in which electrolytes such as conductive salts, ionic liquids, substances for electrolytic conversion such as carbon dioxide, which may be dissolved in water for example, additives for improving the solubility and/or wetting characteristics, defoamers, etc. may optionally additionally be present. The catholyte may include carbon dioxide for example.

The liquids or solvents, any additional electrolytes such as conductive salts, ionic liquids, substances for electrolytic conversion, additives for improving solubility and/or wetting characteristics, defoamers, etc. may be present at least in one electrode space or in both electrode spaces. It is also possible in each case for two or more of the substances or mixtures mentioned to be included. These are not particularly restricted and may be used on the anode side and/or on the cathode side.

The electrolysis cell or the electrolysis system may be used, for example, in an electrolysis of carbon dioxide and/or CO. The above embodiments, configurations and developments can, if viable, be combined with one another as desired. Further possible configurations, developments and implementations of the invention also include combinations that have not been mentioned explicitly of features of the invention that have been described above or are described hereinafter with regard to the working examples. More particularly, the person skilled in the art will also add individual aspects to the respective basic form of the present invention as improvements or supplementations.

The teachings herein are elucidated further in detail hereinafter with reference to various examples thereof. However, the scope of the disclosure is not limited to these examples.

### EXAMPLES

Reference Example: Creation of Pourbaix Diagrams

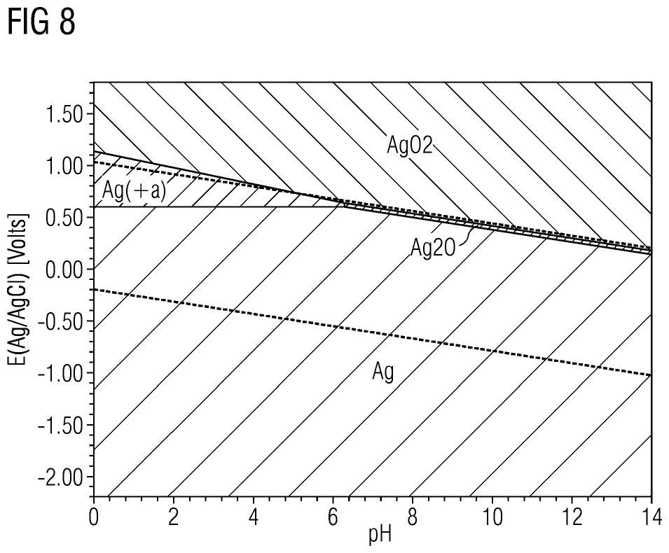

The Pourbaix diagrams shown in FIGS. 8 to 15 were calculated by the HSC Chemistry 9 Software, EpH Module 9.0.1, Research Center Pori, Outotec, Finland, 2015. The method is based on STABCAL (Stability Calculations for Aqueous Systems), developed by H. H. Haung from Montana Tech., USA, in accordance with the details in Haung, H.: Construction of Eh—pH and other stability diagrams of uranium in a multi-component system with a microcomputer—I. Domains of predominance diagrams, Canadian Metallurgical Quarterly, 28 (1989), July-September, p. 225-234, and Haung, H.: Construction of Eh—pH and other stability diagrams of uranium in a multicomponent system with a microcomputer—II. Distribution diagrams. Canadian Metallurgical Quarterly, 28 (1989), July-September, p. 235-239. The Pourbaix diagrams were calculated for the respective system at 25.00° C. with a molality of 1 and standard pressure. What is shown in each case is the potential in volts versus an Ag/AgCl electrode as a function of pH.

### Example 1

On the laboratory scale, silver powder (starting weight 40 g; particle size <75 μm by sieve analysis) is mixed using a cutting mill (IKA) (on a large scale, for example, with an intensive mixing apparatus) with silver(I) sulfate particles (starting weight 5 g; particle size <75 μm by sieve analysis) and PTFE particles (starting weight 5 g; Dyneon® TF 1750; particle size (d50)=8 μm according to manufacturer). The mixing procedure follows the following process: grinding/mixing for 30 sec and pause for 15 sec for a total of 6 min. This specification is based on the cutting mill with total loading 50 g. According to the amount of powder and polymer chosen or chain length, the mixing time before this state is achieved may also vary. The powder mixture obtained is subsequently scattered or sieved onto a silver mesh having a mesh size of >0.5 mm and <1.0 mm and a wire diameter of 0.1-0.25 mm in a bed thickness of 1 mm.

In order that the powder does not trickle through the sieve, the reverse side of the Ag mesh can be sealed with a film which is not subject to any further restriction. The prepared layer is compacted with the aid of a two-roll device (calender). The rolling process itself is characterized in that a reservoir of material forms in front of the roll. The speed of the roll is between 0.5-2 rpm and the gap width was adjusted to the height of the carrier+40% to 50% of the bed height Hf of the powder, or corresponds roughly to the thickness of the mesh+feed margin 0.1-0.2 mm.

The gas diffusion electrode obtained is activated in an electrolysis bath in a 1 M KHCO₃ solution for 6 h at a current density of 15 mA/cm².

### Example 2

The production of the gas diffusion electrode in example 2 corresponds to that in example 1, except that silver oxide is used rather than silver sulfate.

The Pourbaix diagram shown in FIG. 8 for the silver-water system has a very narrow existence region for Ag⁺ and Ag₂O at thermodynamic equilibrium.

### Example 3

The production of the gas diffusion electrode in example 3 corresponds to that in example 1, except that silver chloride is used rather than silver sulfate.

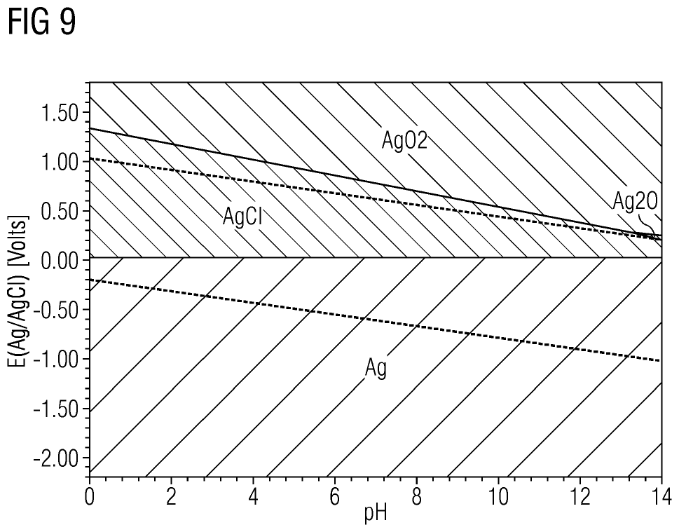

The Pourbaix diagram shown in FIG. 9 for the Ag—Cl system, by contrast with the system shown in FIG. 8, has a much broader existence region for the AgCl system. The highly complexing effect of Cl and the formation of sparingly soluble AgCl promotes existence at more negative potentials. As soon as oxidation takes place, complexation can be effected.

### Example 4

The production of the gas diffusion electrode in example 4 corresponds to that in example 1, except that silver bromide is used rather than silver sulfate.

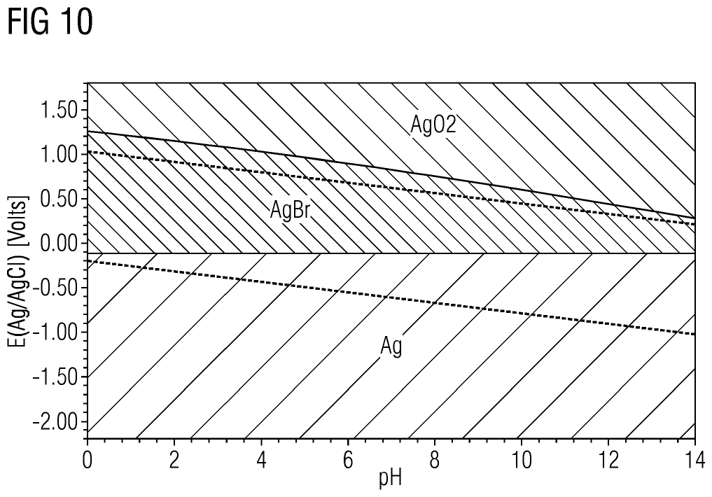

The Pourbaix diagram shown in FIG. 10 for the Ag—Br system, by contrast with the system shown in FIG. 8, likewise has a much broader existence region for the AgBr system. The highly complexing effect of Br and the formation of sparingly soluble AgBr likewise promotes existence at more negative potentials. As soon as oxidation takes place, complexation can be effected.

### Example 5

The production of the gas diffusion electrode in example 5 corresponds to that in example 1, except that silver sulfide Ag₂S is used rather than silver sulfate.

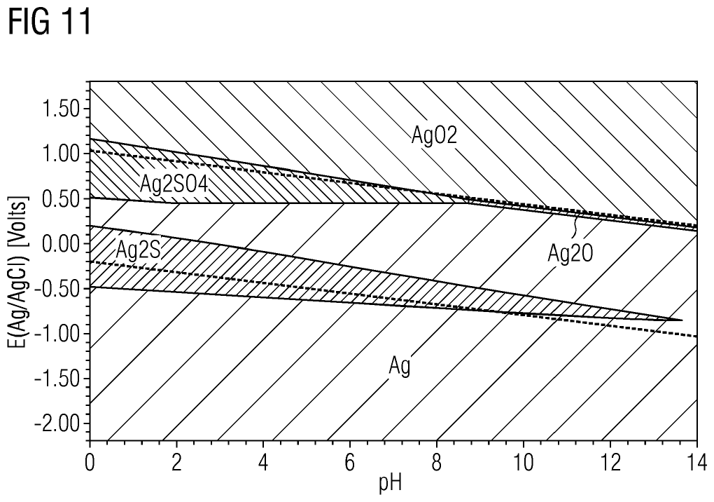

The Pourbaix diagram shown in FIG. 11 for the Ag—S system shows a relatively broad existence region for sparingly soluble silver sulfide. The phase is stable under equilibrium conditions at negative electrode potential down to −0.8 V vs. Ag/AgCl. Under real electrolysis conditions of, for example, −1.5 to −1.6 V vs. Ag/AgCl, existence is thus probable.

### Example 6

The production of the gas diffusion electrode in example 6 corresponds to that in example 1, except that Ag₂Se is used rather than silver sulfate.

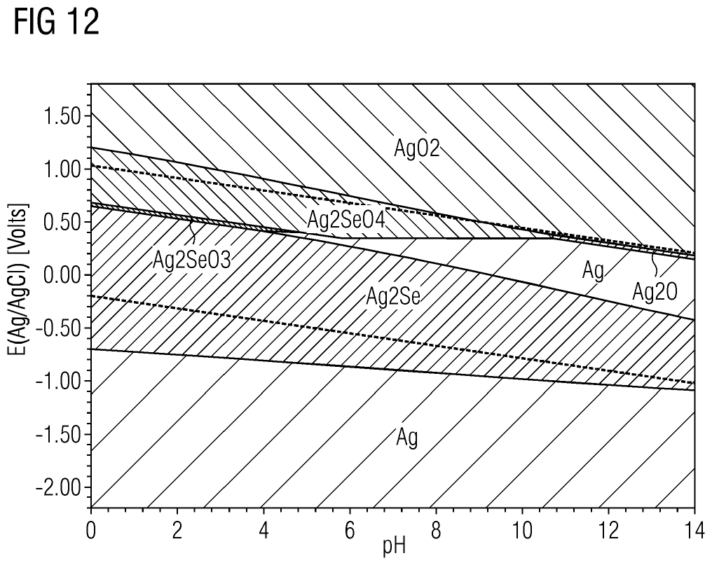

Similarly to the Ag—S system shown in FIG. 11, the Pourbaix diagram shown in FIG. 12 for the Ag—Se system shows a very broad existence region for the Ag₂Se phase, which is stable under equilibrium conditions down to a potential of −1.0 V vs. Ag/AgCl. Ag₂Se is sparingly soluble and is a semiconductor, which means that the material is suitable for production of electrodes. Here too, existence under real electrolysis conditions, for example as specified above, is probable.

### Example 7

The production of the gas diffusion electrode in example 7 corresponds to that in example 1, except that Ag₂Te is used rather than silver sulfate.

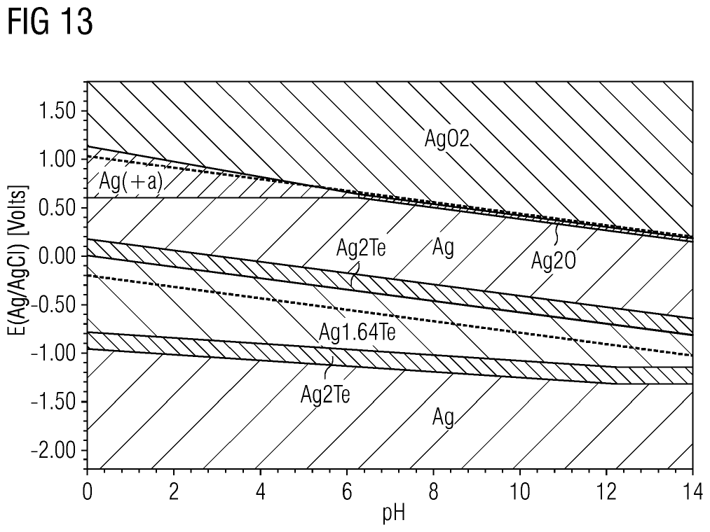

As in the Pourbaix diagram shown in FIG. 13 for the AgTe system, the Ag—Te system has the phases Ag₂Te, Ag_{1.64}Te, which are stable down to a potential of −1.3 V vs. Ag/AgCl. Ag₂Te likewise has semiconductive properties.

### Example 8

The production of the gas diffusion electrode in example 8 corresponds to that in example 1, except that Ag₃Sb is used rather than silver sulfate.

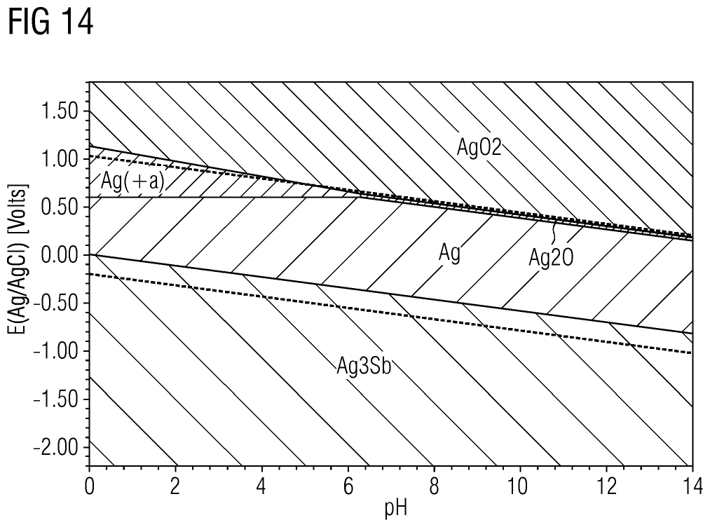

The Pourbaix diagram shown in FIG. 14 for the Ag₃Sb system (dyscrasite) here shows a very broad existence region for the Ag₃Sb phase, which exists down to a potential of −2 V versus Ag/AgCl over a pH range of 0-14.

### Example 9

The production of the gas diffusion electrode in example 9 corresponds to that in example 1, except that AgP₃ is used rather than silver sulfate.

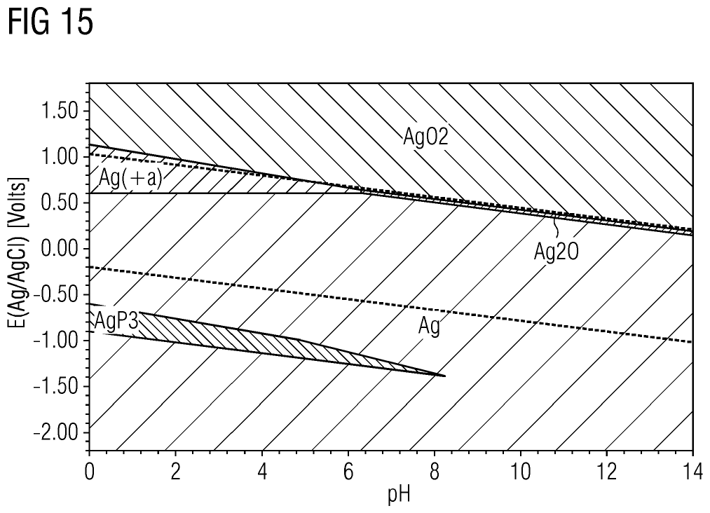

The Ag—P system has a narrow phase existence region for AgP₃, silver triphosphite, in an acidic medium down to −1.3 V vs. Ag/AgCl, as shown in the Pourbaix diagram in FIG. 15.

Electrification of the chemical industry means replacing processes that have been conducted by conventional thermal methods to date by electrochemical processes. For example, in a single electrochemical step in aqueous media, CO can be efficiently prepared from CO₂ over silver-based electrodes, for example, with silver as metal M over the novel catalysts of the invention.

Competing hydrogen formation can be suppressed by mixing metal cations such as Ag⁺ into the gas diffusion electrode. Silver oxide or corresponding compounds of the metal M can, however, be reduced to silver or metal M under operating conditions. This corresponds in principle to the standard procedure of activation of a gas diffusion electrode.

In order to avoid this reduction, then, sparingly soluble compounds of the metal M, for example silver halides, chalcogenides or pnictides, or complex anions that are difficult to reduce, are mixed into the metal M, for example the silver component, of the gas diffusion electrode.

In this way, the gas diffusion electrodes of the invention can efficiently reduce CO₂ and/or CO even over prolonged periods of time.

What is claimed is:

1. A gas diffusion electrode comprising:
a) a metal M selected from the group consisting of: Ag, Au, Cu, and Pd; and
b) a compound of the metal M;
wherein the compound has a solubility in water at 25° C. and standard pressure of less than 0.1 mol/L;
wherein the compound has a formula selected from the group consisting of: M₁₋ₓX, M_{2-y}Y, M_{2-y}Y′_{w} and M_{3-z}Z, where w≥2; 0≤x≤0.5, 0≤y≤1, and 0≤z≤1.5;
wherein X is selected from the group consisting of: Cl, Br, Br₃, I, I₃, P₃, As₃, As₅, As₇, Sb₃, Sb₅, and Sb₇;
wherein Y is selected from the group consisting of: S, S, and Te;
wherein Y′ is selected from the group consisting of: S, Se, and Te; and
wherein Z is selected from the group consisting of: P, As, Sb, Bi, P₃, As₃, As₅, As₇, Sb₃, Sb₅, Sb₇, molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M, and compounds of the formula MₐX_{b}Y_{c}Z_{d} where a≥2, 0≤b≤4, 0≤c≤8, 0≤d≤4, wherein b and c are not both 0.

2. The gas diffusion electrode as claimed in claim 1, wherein the metal M has a valency of 2 or less.

3. The gas diffusion electrode as claimed in claim 1, wherein the compound has a redox potential below that of Ag₂O relative to the standard hydrogen electrode at a pH of 7, a temperature of 25° C., and standard pressure.

4. The gas diffusion electrode as claimed in claim 1, further comprising a polymer binder.

5. The gas diffusion electrode as claimed in claim 4, wherein the polymer binder has been modified with Ag⁺-binding groups.

6. A method of electrolysis of CO₂ and/or CO, the method comprising:
electrolyzing CO₂ and/or CO; and
using a cathode comprising:
a) a metal M selected from the group consisting of: Ag, Au, Cu, and Pd; and
b) a compound of the metal M;
wherein the compound has a solubility in water at 25° C. and standard pressure of less than 0.1 mol/L;
wherein the compound has a formula selected from the group consisting of: M₁₋ₓX, M_{2-y}Y, M_{2-y}Y′_{w} and M_{3-z}Z, where w≥2; 0≤x≤0.5, 0≤y≤1, and 0≤z≤1.5;
wherein X is selected from the group consisting of: Cl, Br, Br₃, I, I₃, P₃, As₃, As₅, As₇, Sb₃, Sb₅, and Sb₇;
wherein Y is selected from the group consisting of: S, S, and Te;
wherein Y′ is selected from the group consisting of: S, Se, and Te; and
wherein Z is selected from the group consisting of: P, As, Sb, Bi, P₃, As₃, As₅, As₇, Sb₃, Sb₅, Sb₇, molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M, and compounds of the formula MₐX_{b}Y_{c}Z_{d} where a≥2, 0≤b≤4, 0≤c≤8, 0≤d≤4, wherein b and c are not both 0.

7. (canceled)

8. A method for producing a gas diffusion electrode, the method comprising:
mixing a powder of a metal M and a compound of the metal M, wherein
M is selected from the group consisting of: Ag, Au, Cu, and Pd,
wherein the compound has a solubility in water at 25° C. and standard pressure of less than 0.1 mol/L;
using the mixture produced to form a gas diffusion electrode;
wherein the compound has a formula selected from the group consisting of: M₁₋ₓX, M_{2-y}Y, M_{2-y}Y′_{w} and M_{3-z}Z, where w≥2; 0≤x≤0.5, 0≤y≤1, and 0≤z≤1.5;
wherein X is selected from the group consisting of: Cl, Br, Br₃, B, 13, P₃, As₃, As₅, As₇, Sb₃, Sb₅, and Sb₇;
wherein Y is selected from the group consisting of: S, S, and Te;
wherein Y′ is selected from the group consisting of: S, Se, and Te; and
wherein Z is selected from the group consisting of: P, As, Sb, Bi, P₃, As₃, As₅, As₇, Sb₃, Sb₅, Sb₇, molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M, and compounds of the formula MₐX_{b}Y_{c}Z_{d} where a≥2, 0≤b≤4, 0≤c≤8, 0≤d≤4, wherein b and c are not both 0.

9. The process as claimed in claim 8, further comprising forming a mixture comprising the powder of the metal M and the powder of the compound of the metal M to give a gas diffusion electrode, and activating the gas diffusion electrode after the production.

10. The process as claimed in claim 9, wherein the activation includes treatment with a reducing agent in a solvent, or exposure to a reducing gas.

11. The process as claimed in claim 8, further comprising adding a binder to the gas diffusion electrode, or mixing a binder into the mixture comprising the powder of the metal M and the powder of the compound of the metal M.

12. The process as claimed in claim 11, wherein the polymer binder has been modified with Ag⁺-binding groups.

13-14. (canceled)

15. A method for producing a gas diffusion electrode, the method comprising:
treating a gas diffusion electrode comprising a metal M electrochemically with a composition that leads to formation of a compound of the metal M that has a solubility in water at 25° C. and standard pressure of less than 0.1 mol/L,
wherein the compound has a formula selected from the group consisting of: M₁₋ₓX, M_{2-y}Y, M_{2-y}Y′_{w} and M_{3-z}Z, where w≥2; 0≤x≤0.5, 0≤y≤1, and 0≤z≤1.5;
wherein X is selected from the group consisting of: Cl, Br, Br₃, I, I₃, P₃, As₃, As₅, As₇, Sb₃, Sb₅, and Sb₇;
wherein Y is selected from the group consisting of: S, S, and Te;
wherein Y′ is selected from the group consisting of: S, Se, and Te; and
wherein Z is selected from the group consisting of: P, As, Sb, Bi, P₃, As₃, As₅, As₇, Sb₃, Sb₅, Sb₇, molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M, and compounds of the formula MₐX_{b}Y_{c}Z_{d} where a≥2, 0≤b≤4, 0≤c≤8, 0≤d≤4, wherein b and c are not both 0.

16. A method for producing a gas diffusion electrode, the method comprising:
treating a gas diffusion electrode comprising a metal M with a gaseous composition that leads to formation of a compound of the metal M that has a solubility in water at 25° C. and standard pressure of less than 0.1 mol/L,
wherein the compound has a formula selected from the group consisting of: M₁₋ₓX, M_{2-y}Y, M_{2-y}Y′_{w} and M_{3-z}Z, where w≥2; 0≤x≤0.5, 0≤y≤1, and 0≤z≤1.5;
wherein X is selected from the group consisting of: Cl, Br, Br₃, I, I₃, P₃, As₃, As₅, As₇, Sb₃, Sb₅, and Sb₇;
wherein Y is selected from the group consisting of: S, S, and Te;
wherein Y′ is selected from the group consisting of: S, Se, and Te; and
wherein Z is selected from the group consisting of: P, As, Sb, Bi, P₃, As₃, As₅, As₇, Sb₃, Sb₅, Sb₇, molybdates, tungstates, selenates, arsenates, vanadates, chromates, manganates, niobates of the metal M and thio and/or seleno derivatives of molybdates, tungstates, selenates, arsenates, vanadates, chromates, manganates, niobates of the metal M, and compounds of the formula MₐX_{b}Y_{c}Z_{d} where a≥2, 0≤b≤4, 0≤c≤8, 0≤d≤4, wherein b and c are not both 0.
